(19) United States
(12) Patent Application Publication
(10) Pub. No.: US 2016/0340750 A1
(43) Pub. Date: Nov. 24, 2016

(54) METHOD AND PLANT FOR PRODUCING LACTOSE CRYSTALS

(71) Applicant: GEA Messo GmbH, Duisburg (DE)

(72) Inventors: Reinhard Scholz, Kerken (DE); Jan A.M.V. van Esch, Eindhoven (NL); Christian Melches, Bochum (DE); Hermann Plate, Moers (DE)

(21) Appl. No.: 15/226,385

(22) Filed: Aug. 2, 2016

Related U.S. Application Data
(63) Continuation-in-part of application No. PCT/EP2015/052725, filed on Feb. 10, 2015.

(30) Foreign Application Priority Data
Feb. 13, 2014 (DE) 102014101843.5

(51) Int. Cl. C13K 5/00

(52) U.S. Cl. CPC C13K 5/00

(57) ABSTRACT

For continuous production of qualitatively high-grade lactose monohydrate crystals from a solution, the invention proposes the preparation of a highly concentrated solution in a falling film evaporator, from the pre-concentrated solution, which is then subjected to continuous cold crystallization with forced circulation and from which a lactose suspension is drawn off that forms the product crystals following separation of the transported solution. The product crystals are thereby obtained directly by solid/liquid separation, without further crystallization steps from the suspension that was drawn off from the cold crystallization. A portion of the mother solution separated off from the product crystals is fed back to a point prior to the inlet to the falling film evaporator, the remainder of the mother solution is discarded.

### CROSS REFERENCE TO RELATED APPLICATIONS

This application is a continuation-in-part application, which claims the priority benefits of International Patent Application No. PCT/EP2015/052725, filed on Feb. 10, 2015, which claims priority from German Application No. DE 10 2014 101 843.5, filed on Feb. 13, 2014, which are hereby incorporated herein by reference in their entirety.

### BACKGROUND OF THE INVENTION

The invention relates to a method for the continuous production of lactose crystals from an aqueous lactose solution.

Aqueous lactose solutions occur during milk processing, in particular as a result of the treatment of whey from which proteins are extracted e.g. by means of membrane filtration, such as e.g. ultrafiltration. By extracting the water proportion, the lactose can be obtained as a solid from the solution. For crystallization, batch processes have previously typically been used.

In many cases, approximately 98% of the protein content are extracted from an aqueous lactose solution initially by means of nanofiltration. The lactose solution which then contains e.g. 1-3% DM (always % by weight of dry matter here and hereinafter) is then extracted from water e.g. by means of reverse osmosis, so that a content of approximately 5-8% DM is obtained. The solution which is pre-concentrated in this way is then heated with evaporation of water (e.g. in a falling film evaporator) to approximately 70° C. and is highly concentrated to 60-70% and is then introduced into a row of cooling containers and cooled resulting in the formation of lactose crystals. The individual cooling containers are then emptied in each case into a centrifuge combination (e.g. decanter and sieve type screw centrifuge) in order to separate the formed lactose crystals from the mother solution. The mother solution is processed further in alternative processes because recirculation to the evaporation prior to the batch crystallization stage would result in viscosity problems owing to the entrained residual content of proteins which are now more highly concentrated in the mother solution. In the case of this known procedural method, the yield of lactose crystals is typically in the range of 62-68%.

Laid-open document WO 03/075643 A2 discloses a method for continuously producing lactose crystals from an aqueous lactose solution, which initially provides a pre-concentration of the solution by means of water evaporation to 45-65% solids content and then a high concentration to approximately 70-80% solids content. The highly concentrated solution is then passed to a cascaded, multistage system for simultaneous concentration, cooling and crystallization in which the lactose solution is cooled by a gas flow such that partial crystallization of the lactose occurs and the solids content increases to 78-88%. Subsequently, this suspension is injected, for complete crystallization, into a spray chamber which is operated by hot air and from which a product containing 90-99% solids content can be extracted, wherein 70-100% of the water still contained therein is bonded as lactose-monohydrate crystals. The individual stages of the system for simultaneous concentration, cooling and crystallization are formed in each case as horizontal, cylindrical containers, the volume of which is only partially filled with solution and a driven shaft fitted with paddles extends through the longitudinal axis thereof and conveys the solution to the next stage with continuous circulation, wherein the air for cooling purposes is guided through the container above the liquid level. This method requires comparatively complex system technology and high energy expenditure for operation.

Another method for producing lactose crystals is disclosed in laid-open document WO 2012/047122 A1 which proceeds from a lactose solution having less than 80% solids content. This solution is heated in a heat exchanger, in particular a rising film or thermosiphon heat exchanger, to 50-90° C. and is guided into an evaporation container in which water evaporates and lactose crystallises. The heat exchanger is connected to the evaporation container in a circuit, so that the solution circulates together with the formed crystals as a suspension. A partial flow of the suspension continuously discharged and directed e.g. to a hydrocyclone in which a suspension having an increased solids content is produced by being separated from the mother solution which is recirculated. The suspension thus obtained is then passed to batchwise-operated cooling tanks in which by means of further crystallization as a result of the cooling of the entrained solution proportion the original grain size of the crystals formed in the evaporation container is increased still further. The suspension discharged from the cooling tanks is then decanted and the separated mother solution is discharged from the process. The moist crystals obtained are washed, centrifuged and finally dried.

Patent document U.S. Pat. No. 4,955,363 A discloses a method for producing lactose crystals from whey, which initially undergo multistage falling film evaporation at a maximum temperature of 75° C. and are concentrated e.g. to 58% DM. The solution which is concentrated in this way is then introduced into a crystallization tank and is cooled therein with agitation of the solution over a period of several hours at a cooling rate of 2° C./h to 15° C., wherein lactose crystals precipitate from the solution. The crystallization tank is emptied via a decanter centrifuge in which the lactose crystals are separated from the mother solution. The mother solution is directed into a temporary store while the crystals are washed and dried after centrifugation. The mother solution separated from the washed crystals in the centrifuge is likewise directed into the temporary store. The mother solution in the temporary store is subjected to a purification procedure, in that the pH value is adjusted to 5.8-7.9 and the mother solution is heated to 60-70° C. The precipitated solids are removed by centrifugation. The separated mother solution is subjected to chromatographic fractionation which provides three fractions, namely a protein fraction to be discharged, a middle fraction which contains lactose and other impurities and is recirculated into the chromatographic fractionation, and a lactose fraction which is recirculated into the crystallization tank.

Laid-open document DE 198 39 209 A1 discloses a method for producing lactose crystals from whey, which uses nanofiltration after removal of protein by means of ultrafiltration to concentrate the whey, wherein 80-90% of the solution is transferred to the permeate (water and salts). The retentate which is supersaturated with lactose is passed to a crystallization tank in which lactose crystals are formed by the addition of seed crystals and optional cooling. The crystals are separated by decanting and are then washed and dried. The mother solution is recirculated at least partially prior to the nanofiltration.

A further method for producing lactose from ultrafiltered whey is disclosed in laid-open document U.S. 2006/0278217 A1. The whey is initially subjected to ion-exchange treatment by means of an anionic and a cationic resin filling in two columns connected one behind the other and is subsequently concentrated and crystallised in method stages, not described in greater detail, by means of water evaporation. After crystallization of the lactose, the crystals are separated and the mother solution is recirculated completely or partially for regenerating the resin fillings in the columns. However, the separated mother solution can also be subjected completely or partially to a chromatographic treatment from which, on the one hand, a lactose-enriched fraction is obtained and, on the other hand, a raffinate is obtained which can be used for regenerating the resin fillings.

### SUMMARY OF THE INVENTION

Of the methods for producing lactose described above, only laid-open document WO 03/075643 A2 includes a continuously operated method stage for lactose crystallization. However, the equipment provided for this purpose is a comparatively complex mechanical device which is operated by a cooling airflow. Although the previously typically used batchwise-operated crystallization tanks are designed in a very simple manner in constructional terms, they require not only a considerable amount of space and piping for a plurality of parallel tanks but also considerable outlay for the regular cleaning work to be performed on the emptied tanks in order to prevent contamination by bacteria.

With regard to the production of lactose, it is generally desired to obtain the solid in the form of lactose-monohydrate, and in particular with the quality being as constant as possible. In general, this can be achieved most effectively by means of continuous process control.

The present invention provides an improved method for producing lactose-monohydrate crystals from a continuously fed aqueous lactose solution in such a manner as to ensure the production of the lactose crystals with the quality being as constant as possible, with the lowest possible expenditure in terms of energy, operational technology and system technology and with the highest possible yield.

This is achieved by a method for continuously producing lactose-monohydrate crystals from a continuously fed aqueous lactose solution which is pre-concentrated to approximately 5-8% DM and from which the originally contained proteins are removed substantially (95-99% of the original content) by means of membrane filtration, so that at most minor residual amounts of protein are present. The pre-concentrated solution is highly concentrated with heat being supplied in falling film evaporation wherein the temperature of the solution is maintained in the range of approximately 50-90° C. at the falling film evaporation outlet and the solution acquires a content of 60-80% DM, wherein the solution is then directed to a continuous cooling crystallization for lactose crystallization, wherein the continuous cooling crystallization is performed at 10-55° C. with continuous circulation of the suspension from which subsequently a lactose suspension is extracted which forms the product crystals after separation of the entrained solution. In accordance with an embodiment of the invention, the product crystals are obtained directly, i.e. without further crystallization steps, from the suspension, which has been extracted from the cooling crystallization, by means of solid/liquid separation. Of course, this is followed by the typical further processing steps for the crystals, such as crystal washing and drying. To increase the yield, it is essential that a portion of the mother solution separated from the product crystals is recirculated upstream of the falling film evaporation inlet and only a residue of the mother solution is discarded, wherein the portion of the mother solution, which is separated from the product crystals, to be recirculated for the purpose of falling film evaporation is subjected beforehand to membrane filtration (e.g. microfiltration, ultrafiltration or nanofiltration) in order to separate proteins and is subjected to precipitation and separation of mineral compounds, in particular calcium and phosphates. Typically, yields in the range of 75-85% can be achieved in this way. By means of the membrane filtration, it is possible to avoid problems relating to a significant increase in viscosity which can otherwise be expected to occur, so that even increases in the yield to values of more than 80% to 95% are permitted. The outlay for this additional membrane filtration is comparatively low because the masses to be overcome are substantially less than in the preparation of the pre-concentrated lactose solution. A small and correspondingly cost-effective system is sufficient for this purpose. The precipitation and separation of mineral compounds permits the best possible level of product quality, i.e. the highest possible degree of purity of the lactose-monohydrate crystals.

It is characteristic of the method in accordance with the invention that in the heat exchanger connected upstream of the continuous cooling crystallization, i.e. in the falling film evaporator, no crystals whatsoever are formed, and instead crystallization takes place exclusively in the continuous crystallization stage. All of the method steps take place in a continuous mode of operation and ensure a constant high level of product quality.

It is, in principle, possible to perform the cooling crystallization by means of surface cooling. In an expedient manner, the cooling crystallization is operated, however, with continuous vacuum cooling in order to keep the time and space requirements as well as energy expenditure as low as possible. Continuous vacuum cooling crystallization very effectively protects against the risk of contamination by bacteria by virtue of being sealed completely towards the outside and therefore also permits a considerable saving in terms of cleaning effort compared with batchwise crystallization. This is complemented by the advantage that during vacuum generation water vapour is continuously extracted from the cooling crystalliser and therefore after the falling film evaporation a further reduction in the water content in the solution is achieved, which increases the total yield of lactose crystals of the method in accordance with the invention. Furthermore, in the case of the continuous cooling crystallization the outlay for the piping and valves is also reduced compared with batchwise-operated crystallization in tanks, as was previously typical.

The cooling crystallization can be performed in the temperature range of 35-50° C., in particular at approximately 40° C. In comparison with known methods, this type of crystallization permits very high crystallization outputs with a comparatively small amount of system outlay.

The falling film evaporation is operated expediently at 65-75° C., preferably at approximately 70° C. Preferably, the extraction of water in the falling film evaporation is performed until the lactose solution then has a solids content of 65-70% DM. The fact that the lactose solution is pre-concentrated by water evaporation offers the considerable advantage that the heating in the falling film evaporation can be integrated very effectively into the thermal management, in particular of a multistage pre-evaporation procedure, expediently established at a similar temperature level.

In some cases, it is advantageous with regard to the thermal management to perform the falling film evaporation in a plurality of stages connected in series.

The suspension can be circulated in the crystallization device in an expedient manner by agitation or by circulation pumping.

### BRIEF DESCRIPTION OF THE DRAWINGS

The invention will be described in greater detail hereinafter with reference to the exemplified embodiment schematically illustrated in the figures, in which:

FIG. 1 shows a system diagram for the method; and

FIG. 2 shows an example of a system comprising a falling film evaporator and a cooling crystalliser.

### DESCRIPTION OF THE PREFERRED EMBODIMENT

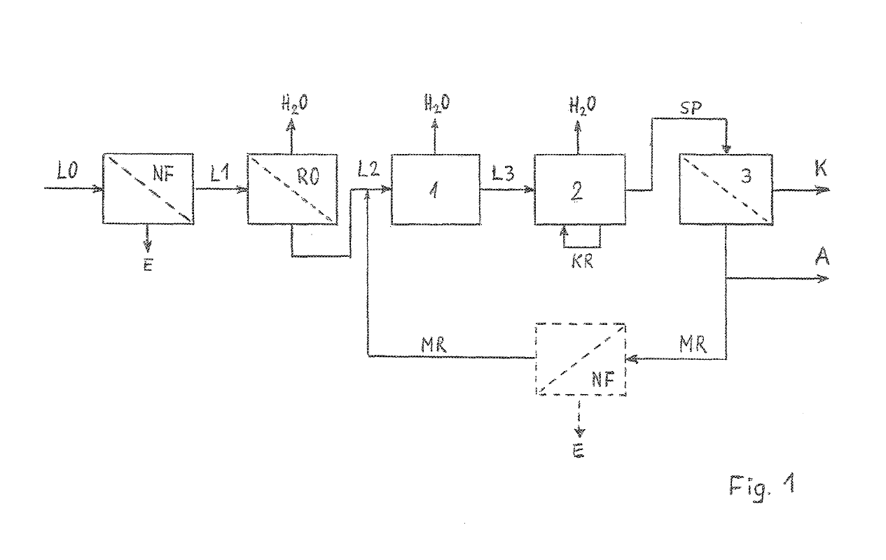

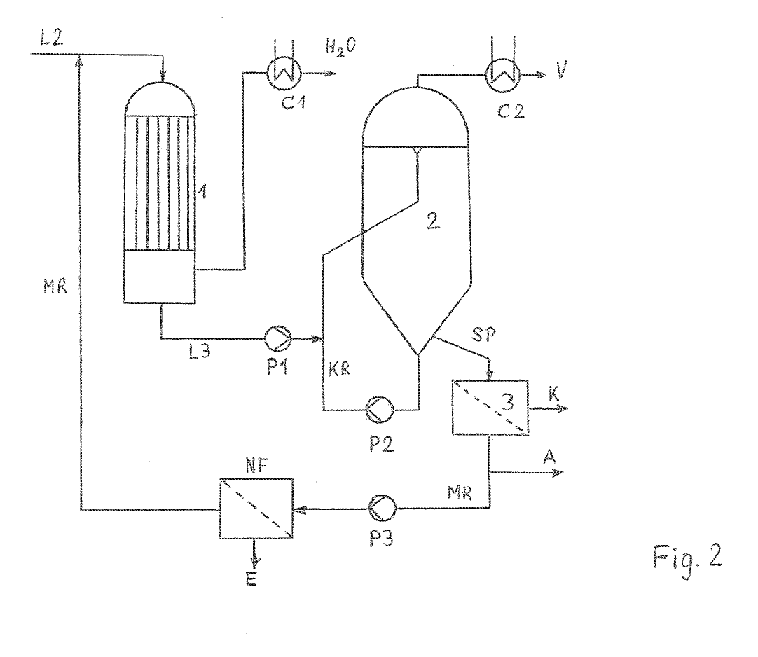

In the system diagram illustrated by way of example in FIG. 1, provision is made that an aqueous lactose solution L0 is initially directed from a source (e.g. cheese production), not illustrated, to membrane filtration NF (e.g. nanofiltration) in which e.g. 98% of the originally contained proteins are extracted. The solution L0 thus obtained then passes into a device for pre-concentrating the solution. This can be designed as pre-evaporation device or even as a reverse osmosis device RO, as in the illustrated diagram. In the pre-concentration procedure, a large portion of the water is extracted from the solution, so that it acquires a content of approximately 4-8% DM. As is also apparent from the detailed partial illustration including the same reference numerals for functionally identical parts in FIG. 2, this pre-concentrated solution L2 is guided into a falling film evaporator 1 for the purpose of highly concentrating the solution L2 by water evaporation. This falling film evaporator 1 could also be designed to have multiple stages. The water proportion evaporated at an operating temperature of the falling film evaporator 1 of e.g. 70° C. is extracted as vapours and condensed in a condenser C1. A highly concentrated solution L3, which typically comprises a content of e.g. 65-70% dry matter DM, is fed from the lower part of the falling film evaporator 1 e.g. by means of a pump P1 to a cooling crystalliser 2 which, for continuous circulation of a crystal suspension, has an external line circuit KR fitted with a pump P2. Instead of the line circuit KR, e.g. an internal agitator could also be provided in the crystalliser 2. The supply line for the highly concentrated solution L3 can issue, as shown, into the circuit line or even directly into the crystallization chamber of the cooling crystalliser 2. The cooling crystalliser 2 is preferably connected to a vacuum generation device V, not illustrated in greater detail, in order to extract the vapours produced in the upper part thereof by evaporation, wherein the vapours are guided in order to be condensed by a condenser C2. As a result of the cooling of the solution which is continuously circulated in the cooling crystalliser 2 and whose temperature is in the range of 10-55° C., typically in the region of approximately 40° C., depending upon the temperature of the solution L3 which is fed, the saturation limit of the solution is exceeded, so that lactose is crystallised and grows into grains which become increasingly larger. This means that in the circuit line KR not only the pure solution is circulated but along with it also the already formed crystals in the form of a suspension. The lactose-monohydrate crystals formed continuously in this manner can be extracted as a suspension SP from the lower part of the cooling crystalliser 2 through a line SP and can be fed to a solid/liquid separating device 3 (e.g. decanter and/or centrifuge) in which the entrained mother solution is separated from the lactose product crystals K. A portion of the separated mother solution can be directed back to the inlet of the falling film evaporator 1 through a line MR, whereas a smaller portion of the mother solution is discharged from the process as waste A in order to avoid a centration of impurities. The typical further steps for processing the produced lactose crystals have not been illustrated.

The method in accordance with this embodiment of the invention for completely continuous lactose-monohydrate crystallization requires a comparatively small amount of energy expenditure and equipment outlay because it results in crystals which can be separated effectively from the mother solution and whose average grain size is typically approximately 0.1-0.2 mm. The energy expenditure for the water evaporation can be minimized in particular by vacuum generation during the cooling crystallization. Furthermore, the method in accordance with this embodiment of the invention permits a particularly high yield of highly pure lactose without large quantities of waste water, in particular if the recirculated mother solution is subjected to removal of proteins and mineral compounds.

The high efficiency of the method according to the invention is demonstrated in the following comparison:

### Comparative Example

A pre-concentrated sweet whey containing 7% DM which had previously been subjected to membrane filtration in order to extract the proteins was subjected to vacuum evaporation. At the end of the vacuum evaporation, the solution had a temperature of approximately 60° C. and a content of 72% DM (51% by weight lactose×H2O, 2.0% by weight protein or substances similar to protein, 6.7% by weight ash in each case as an absolute % of the solution). This warm solution was introduced successively into batch crystallization containers connected in parallel with one another and was cooled in each case to approximately 25° C. over a period of approximately 24 h. The lactose crystals formed were then separated by means of a screen centrifuge, washed and dried in each case. The crystals had an ash content of 0.1% by weight. The separated mother solution which still comprised 18% by weight lactose and 9% by weight ash proportion was directed for further use as animal feed. The yield of lactose-monohydrate was approximately 67%.

### Exemplified Embodiment of the Invention

A similar sweet whey pre-concentrate (7.2% DM) from which protein had already been extracted as in the comparative example was introduced to a falling film evaporation and at the outlet thereof had a content of 72% DM (50% by weight lactose×H2O, 2.0% by weight protein or substances similar to protein, 6.7% by weight ash as an absolute % of the solution) and a temperature of approximately 70° C. The warm solution was introduced into a fully continuously operated vacuum cooling crystallizer having an operating temperature of approximately 35° C. from which a crystal suspension flow was continuously extracted and introduced into a screen centrifuge. The crystals were washed with water and dried. Of the separated mother solution, which contained approximately 20% by weight lactose, 4% by weight protein or substances similar to protein and approximately 12% by weight ash proportion, ca. 10% was removed from the process as waste, whereas the remaining quantity was subjected to membrane filtration for renewed separation of protein or substances similar to protein and was subjected to precipitation of mineral compounds (calcium and phosphates). After separation of the solids, the purified mother solution was recirculated to the falling film evaporation. The lactose crystals produced had a constant ash content of 0.1%. The yield of lactose was approximately 90%.

### LIST OF REFERENCE NUMERALS

1 falling film evaporator
2 crystallization device
3 solid/liquid separating device
A waste line
C1 condenser
C2 condenser
E proteins
K product crystals
KR circuit line
L0 fresh lactose solution
L1 lactose solution substantially free of proteins
L2 pre-concentrated lactose solution
L3 highly concentrated lactose solution
MR line for recirculated mother solution
NF membrane filter system
P1 pump
P2 pump
P3 pump
RO device for reverse osmosis
SP line for extracting the suspension including the product crystals
V vacuum generation

1. Method for continuously producing lactose-monohydrate crystals from a continuously fed aqueous lactose solution which is pre-concentrated to 5-8% DM and from which the originally contained proteins are removed by means of membrane filtration, the method comprising:
highly concentrating the pre-concentrated solution with heat being supplied in falling film evaporation, including maintaining the temperature of the solution in the range of 50-90° C. at the falling film evaporation outlet and the solution acquires a content of 60-80% DM;
directing the solution then to a continuous cooling crystallization for lactose crystallization, wherein the continuous cooling crystallization is performed at 10-55° C. with continuous circulation of the suspension;
continuously extracting a lactose suspension from the cooling crystallization and obtaining the product crystals directly without further crystallization steps from the extracted suspension using solid/liquid separation and by performing crystal washing and drying;
recirculating a portion of the mother solution separated from the product crystals upstream of the falling film evaporation inlet and discarding the residue of the mother solution;
wherein the portion of the mother solution that is separated from the product crystals to be recirculated for the purpose of falling film evaporation is subjected to membrane filtration in order to separate proteins and is subjected to precipitation and separation of mineral compounds.

2. Method as claimed in claim 1 wherein the cooling crystallization is operated with continuous vacuum cooling.

3. Method as claimed in claim 1 wherein the cooling crystallization is operated in the temperature range 35-55° C.

4. Method as claimed in claim 1 wherein the falling film evaporation is operated at 65-75° C.

5. Method as claimed in claim 1 wherein the suspension is circulated in the crystallization device by agitation or by circulation pumping.

6. Method as claimed in claim 1 wherein the falling film evaporation is performed in a plurality of stages connected in series.

7. Method as claimed in claim 1 wherein the extraction of water in the falling film evaporation is performed until the solids content in the lactose solution is 65-70% DM.

8. Method as claimed in claim 1 wherein the mineral compounds comprise calcium and phosphates.

9. Method as claimed in claim 3 wherein the cooling crystallization is operated at 40° C.

10. Method as claimed in claim 4 wherein the falling film evaporation is operated at 70° C.

11. Method as claimed in claim 2 wherein the cooling crystallization is operated in the temperature range 35-55° C.

12. Method as claimed in claim 11 wherein the cooling crystallization is operated at 40° C.

13. Method as claimed in claim 2 wherein the falling film evaporation is operated at 65-75° C.

14. Method as claimed in claim 13 wherein the falling film evaporation is operated at 70° C.

15. Method as claimed in claim 3 wherein the falling film evaporation is operated at 65-75° C.

16. Method as claimed in claim 15 wherein the falling film evaporation is operated at 70° C.

17. Method as claimed in claim 2 wherein the suspension is circulated in the crystallization device by agitation or by circulation pumping.

18. Method as claimed in claim 3 wherein the suspension is circulated in the crystallization device by agitation or by circulation pumping.

19. Method as claimed in claim 4 wherein the suspension is circulated in the crystallization device by agitation or by circulation pumping.

20. Method as claimed in claim 2 wherein the falling film evaporation is performed in a plurality of stages connected in series.

21. Method as claimed in claim 3 wherein the falling film evaporation is performed in a plurality of stages connected in series.

22. Method as claimed in claim 4 wherein the falling film evaporation is performed in a plurality of stages connected in series.

23. Method as claimed in claim 5 wherein the falling film evaporation is performed in a plurality of stages connected in series.

24. Method as claimed in claim 2 wherein the extraction of water in the falling film evaporation is performed until the solids content in the lactose solution is 65-70% DM.

25. Method as claimed in claim 3 wherein the extraction of water in the falling film evaporation is performed until the solids content in the lactose solution is 65-70% DM.

26. Method as claimed in claim 4 wherein the extraction of water in the falling film evaporation is performed until the solids content in the lactose solution is 65-70% DM.

27. Method as claimed in claim 5 wherein the extraction of water in the falling film evaporation is performed until the solids content in the lactose solution is 65-70% DM.

28. Method as claimed in claim 6 wherein the extraction of water in the falling film evaporation is performed until the solids content in the lactose solution is 65-70% DM.
